(19) United States
(12) Patent Application Publication
(10) Pub. No.: US 2013/0142013 A1
(43) Pub. Date: Jun. 6, 2013

(54) SYSTEMS AND METHODS FOR MARINE ANTI-FOULING

(71) Applicants: Robert Seth Hartshorne, Burwell (GB); Gary John Tustin, Sawston (GB); Joseph Hannah, Hardwick (GB)

(72) Inventors: Robert Seth Hartshorne, Burwell (GB); Gary John Tustin, Sawston (GB); Joseph Hannah, Hardwick (GB)

(73) Assignee: WESTERNGECO L.L.C., HOUSTON, TX (US)

(21) Appl. No.: 13/514,935

(22) PCT Filed: Nov. 15, 2010
(86) PCT No.: PCT/IB10/02928

§ 371 Date: Feb. 13, 2013

Related U.S. Application Data
(60) Provisional application No. 61/285,377, filed on Dec. 10, 2009.

(51) Int. Cl. G01V 1/20

(52) U.S. Cl. CPC G01V 1/201
USPC 367/153; 264/176.1; 264/173.16

(57) ABSTRACT

An anti-biofouling casing for a seismic streamer is provided, the casing comprising an outer-skin, the outer skin comprising a mix of a base material and a molecular additive, wherein the molecular additive is localized throughout the base material and the molecular additive is configured to impart a high contact angle and/or a low surface energy to an outer surface of the anti-biofouling casing to prevent adhesion of living organism thereto. The outer-skin may comprise a casing/skin for a seismic streamer such that the streamer skin comprises a base material with a hydrophobic molecular additive distributed throughout the streamer skin.

### BACKGROUND

Biofouling, the attachment of marine species to marine equipment and vessels, can cause serious problems to marine operations. With regard to marine seismic surveying, biofouling, which is generally, barnacle fouling/attachment, is a costly problem for the seismic industry. For example, towing streamers fouled with marine species, such as barnacles, as illustrated in FIG. 1, can result in increased fuel consumption for the towing vessel due to induced augmented drag/turbulent flow. Furthermore, the mass of heavily fouled streamers may result in streamer sections breaking under the resulting strain. Additionally, prior to streamers being reeled back onto vessels, post-operations, adhered marine species, barnacles, etc., must be physically removed. This removal process is a time-consuming, manual, mechanical release process that can culminate in economic losses resulting from lost-production time and added labour costs as well as potential damage to integrity of the seismic streamer.

A typical seismic streamer comprises sensors, strength members and cabling housed all disposed within a polyurethane casing. The casing may be manufactured from an extruded layer of flexible polyurethane tubing or the like that functions to protect the components of the streamer from the marine environment. It is the outer surface of this casing that provides a surface suitable for biofouling, such as barnacle colonization. Although casing materials, such as polyurethane, are typically difficult to chemically or biologically adhere to, biofouling, by barnacles, in particular, is problematic in the marine seismic industry.

There are several steps that culminate in the barnacle colonization process. Once the streamer surface is immersed in water it is immediately covered with a thin ‘conditioning’ film consisting mainly of proteins and other dissolved organic molecules. This initial step is followed by the adhesion of single floating bacteria. Once attached, the bacteria begin to generate extra-polysaccharide (“EPS”) layers that result in inter-bacterial network formation and enhanced adhesion to the immersed surface. This process is generally termed micro-fouling and results in biofilm formation. The micro-fouling process is believed to strongly contribute to rapid colonization by macro-foulers (e.g., barnacles) as the biomass-rich biofilm provides a readily-available food source.

Antifouling paints have long been the most effective method to prevent macrofouling of steel-hulled marine vessels. In such paints, biocides or heavy metal compounds, such as tributyltin oxide (“TBTO”), are released (leached) from the paint to inhibit microorganism attachment. Typically these paints are composed of an acrylic polymer with tributyltin groups attached to the polymer via an ester bond. The organotin moiety has biocidal properties and is acutely toxic to the attached organisms. TBT compounds are historically the most effective compounds for biofouling prevention, affording protection for up to several years.

Unfortunately, TBT compounds are also toxic for non-target marine organisms. Furthermore, TBT compounds are not biodegradable in water and, as a result, the compounds may accumulate in water and pose an environmental hazard. Because of these factors, the International Maritime Organization (IMO) banned the application of TBT compounds in 2003 and required the removal of all TBT coatings, worldwide by 2008. Alternative strategies have thus been sought for preventing marine biofouling that have much lower general toxicity and as such are more environmentally acceptable.

In the seismic industry, the systems and methods for preventing the biofouling of seismic streamers used to acquire seismic data comprise applying paints or attaching coatings to the streamer skin; the skin of the seismic streamer is typically a polyurethane layer/envelope that surrounds the sensor system of the seismic streamer. As such, the generation of an antifouling strategy for seismic streamers has previously focused primarily on two different approaches.

The first general strategy for preventing fouling on seismic streamers is based on the use of a biocidal compound on the streamer skin. A wide array of chemicals are known to be anti-microbial by nature. These anti-microbial chemicals include various polymers—e.g. polyethylene oxide, polyacrylamide—quaternary ammonium salts—e.g. benzylalkonium chloride—and organic compounds—such as Diuron. With regard to seismic streamers, compounds have been used with the streamer skin that are biologically active against organisms that settle on the surface of the tubing and, therefore act as a post-settlement strategy. One issue with the antifouling approach of using biocides is that while the biocide kills organisms on the surface of the streamer, the organism is not removed from the surface. As such, the biofouled surface remains on the streamer and may act as a colonization initiation point for continued/new biofouling.

The second approach to biofouling of seismic streamers, involves applying a silicone-based coating to the skin of the streamer, which coating acts to prevent the initial adhesion, or aids with the removal of macro-fouling organisms by generating a hydrophobic/high contact angle streamer surface. Silicones have unique properties that make them useful as antifouling coatings. Silicone-based coatings are typically based on the incorporation of polydimethylsiloxane (PDMS) into a coating that is applied to a surface of the seismic streamer. PDMS comprises methyl (—CH₃) side chains that give rise to a low surface energy (20-24 mJ/m²) and a flexible, inorganic silicon oxide (—Si—O) backbone linkage that creates an extremely low elastic modulus (˜1 MPa). Both these properties of PDMS are believed to be essential to the low adhesion properties of the silicone coatings.

The typical skin of a seismic streamer comprises polyurethane, which is a substrate on which it is difficult to chemically and or physically adhere the hydrophobic/high contact angle antifouling coatings of the prior art. A method of overcoming the issues of chemical adhesion of silicon polymers to polyurethane as well as the resulting break-down/destruction of the polymer coating with ageing is based on the application of an intermediate layer (tie-coat) to the polyurethane followed by application of a silicone-elastomer coating that is adhered to the intermediate tie-coat layer via a heat-curing process. However, in field experiments, although the silicone-outer layer applied to the skin of the streamer in this way was demonstrated to prevent barnacle-fouling in the short term, after a certain period of time, de-lamination of the outer silicone elastomer coating was observed. Moreover, in the field testing, de-lamination of the coating from the polyurethane tube was exacerbated during the operational process of reeling streamers onto and off marine vessels before and after seismic shooting. The propensity of silicone coatings to delaminate from the polyurethane streamer skin is an intrinsic property of the coating due to the intrinsically low resistance of the coatings to abrasion. Notably, in areas in which delamination was most evident on the streamer, rapid barnacle-colonization of the streamer surface was observed. In fact, the prior art method of laminate silicon polymer coatings may, in the long run, actually increase biofouling.

As discussed above, the previous methods of addressing biofouling of seismic streamers has been to apply coatings or paints to the streamer skin. The application of coatings and paints to the streamer have been pursued as the paints and coatings can be applied directly to a formed streamer casing/skin and, as such, there is no issue about, among other things, the coating and/or paint interacting with the constituents of the streamer, adversely affecting the strength or operational characteristics of the streamer, adversely affecting the fabrication of the streamer skin and/or interacting with the internal elements of the seismic streamer; for example, many seismic streamers comprise kerosene as a void filing material within the streamer, and the kerosene may adversely interact with the constituents of the coating or paint. As a solution to biofouling, the application of coatings and paints to the skin of the seismic streamer has not been effective because of the break down/disintegration/delamination of such coatings and paints under field conditions.

### BRIEF SUMMARY

In an embodiment of the present invention, an anti-biofouling casing for a seismic streamer is provided, the casing comprising an outer-skin, the outer skin comprising a mix of a base material and a molecular additive, wherein the molecular additive is localized throughout the base material and the molecular additive is configured to impart a high contact angle and/or a low surface energy to an outer surface of the anti-biofouling casing to prevent adhesion of living organism thereto. In aspects of the present invention, the outer-skin comprises the entire casing for the streamer, such that the streamer skin comprises the base material and the molecular additive distributed throughout the streamer skin.

In an aspect of the present invention, the molecular weight of the additive is configured to provide that the additive selectively migrates to a surface of the anti-biofouling casing. Merely by way of example, the additive may be configured to have a high or ultra-high-molecular-weight to provide for the selective migration to the surface of the anti-biofouling casing.

In another embodiment of the present invention, the anti-biofouling casing also comprises an inner-skin, where the inner-skin comprises the base material without the molecular additive. In such an embodiment, the inner-skin and the outer-skin comprise a multi-layer casing, where the inner-skin and the outer-skin are annealed together and may be applied to the seismic streamer. In certain aspects, to manufacture the multi-layer casing the inner-skin and the outer-skin may be heat extruded simultaneously to provide for annealing of the inner and outer skins.

In one embodiment of the present invention, a method of fabricating a seismic streamer using a biofouling casing comprising the base material and the molecular additive is provided, wherein the biofouling casing is heat extruded onto the seismic streamer. In an alterative embodiment of the present invention, a method of fabricating a seismic streamer is provided wherein an outer-skin comprising a base material and a molecular additive is simultaneously heat extruded with an inner-skin, comprising the base material, onto the seismic streamer.

In an embodiment of the present invention, a method of fabricating and anti-biofouling casing for a seismic streamer is provided, the method comprising mixing a base material and a molecular additive, wherein the molecular additive is configured to impart a hydrophobic and/or low surface energy to an outer surface of the anti-biofouling casing to prevent adhesion of living organism thereto and heat extruding the mixture of the base material and the molecular additive.

### BRIEF DESCRIPTION OF THE DRAWINGS

In the figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The present invention will become more fully understood from the detailed description and the accompanying drawings, wherein:

FIG. 1 is an illustration depicting biofouling of a marine seismic streamer;

FIG. 2 illustrates a cross-section of a marine seismic streamer;

FIG. 3A illustrates contact angles for effective aqueous glue attachment of an organism to a polyurethane surface;

FIG. 3B illustrates a contact angle on a polyurethane surface;

FIG. 3C illustrates contact angles for inneffective aqueous glue attachment of an organism to a silicon coated polyurethane surface.

FIG. 4A illustrates antifouling additives localized throughout a streamer skin, in accordance with an embodiment of the present invention;

FIG. 4B illustrates migration of antifouling additives to surfaces of a streamer, in accordance with an embodiment of the present invention;

FIG. 4C illustrates a streamer skin comprising an outer-skin comprising base material and antifouling additives and an inner-skin comprising base material, in accordance with an embodiment of the present invention;

FIGS. 5A and 5B illustrate contact angles produced by untreated polyurethane and a polyurethane comprising anti-biofouling additive, in accordance with an embodiment of the present invention; and

FIG. 6 is a flow-type illustration of methods for manufacturing anti-biofouling seismic streamer skins, in accordance with embodiments of the present invention.

### DETAILED DESCRIPTION

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the scope of the invention as set forth in the appended claims.

Specific details are given in the following description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As described above, there is a long felt need in the seismic industry for an anti-biofouling system to prevent the biofouling of seismic streamers, which biofouling interferes with the operation of the streamers and requires costly maintenance operations. More specifically, there is a long felt need for an anti-biofouling system that overcomes issues inherent to coating strategies, in particular poor coating adhesion and premature coating removal from the polyurethane surface during exposure or use.

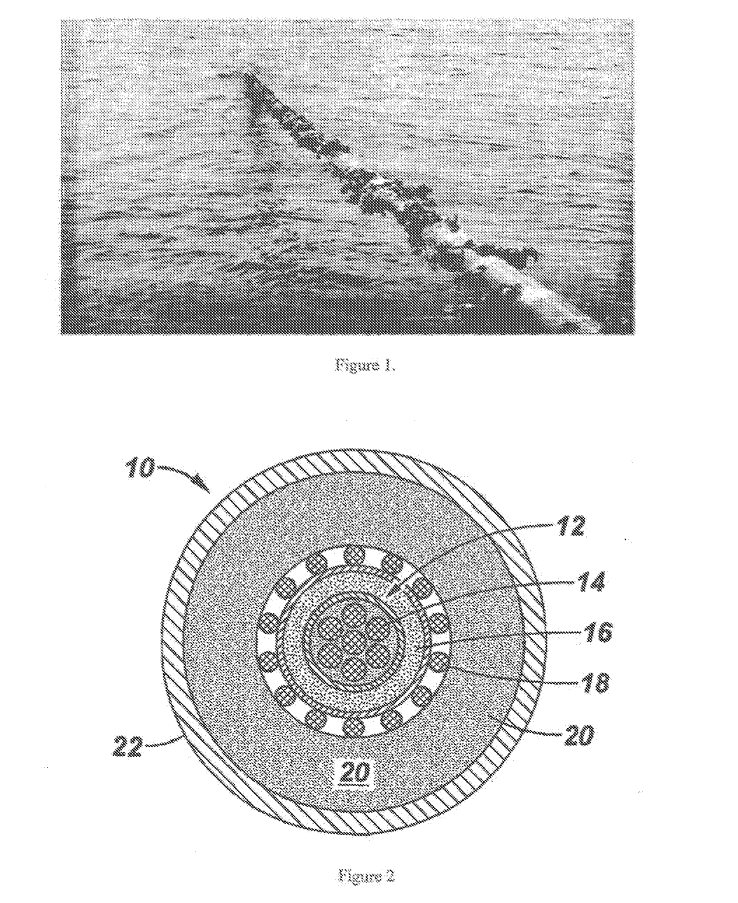

FIG. 2 illustrates a cross-section of a marine seismic streamer. The streamer 10 includes a central core 12 having a transmission bundle 14 surrounded by a strength member 16. The central core 12 is typically pre-fabricated before adding sensors and/or sensor electronics. Local wiring 18, which is used to connect the sensor and sensor electronics, is also disposed in the streamer 10 inside of a body 20 and a skin 22. In certain aspects, the body 20 may comprise a polymer body, a support structure and/or the like for holding the internal mechanisms of the streamer 10.

The body 20 may be filled with a liquid, get solid and/or the like to provide for communication of the internal mechanisms of the streamer 10 with the water surrounding the streamer. In general, seismic streamers have been filled with liquid kerosene to provide for communication of the internal mechanisms of the streamer 10 with the water surrounding the streamer. As such, the composition of the skin 22 has been an issue with respect to the constituents of the skin 22 since the kerosene may adversely interact with certain constituents of the skin 22.

The typical way to dispose the wiring 18 within the streamer cable 10 is to twist the wiring onto the central core 12 with a certain lay-length (or pitch) to allow for tensile cycling and bending of the streamer cable 10 without generating high stresses in the wires. Wiring layers in cables are often pre-made with the central core 12.

In some embodiments of the present invention, the streamer 10 may comprise a field streamer, comprising a fluid such as kerosene. In other embodiments of the present invention the streamer 10 may comprise a solid streamer with a solid/gel-type material disposed around the core of the streamer 10. Merely by way of example, for solid streamers it may be of importance to prevent biofouling so that the solid streamer may be properly maintained and for proper operation of the solid streamer. As such, by using an anti-biofouling system and method in accordance with an embodiment of the present invention, the operation of the solid streamer may be enhanced.

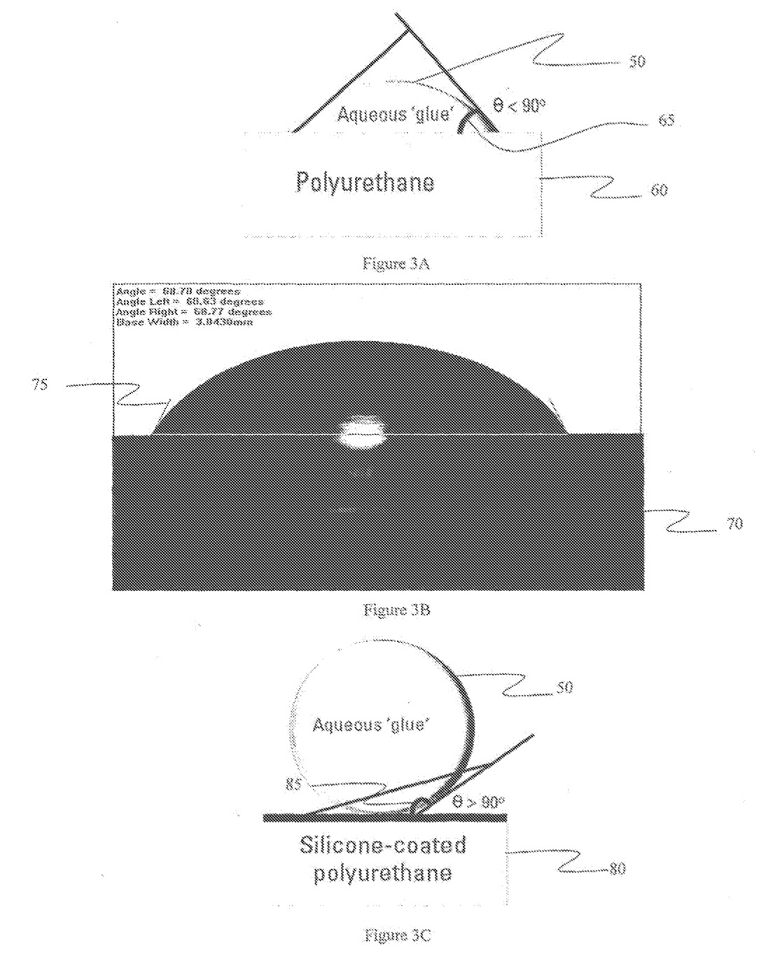

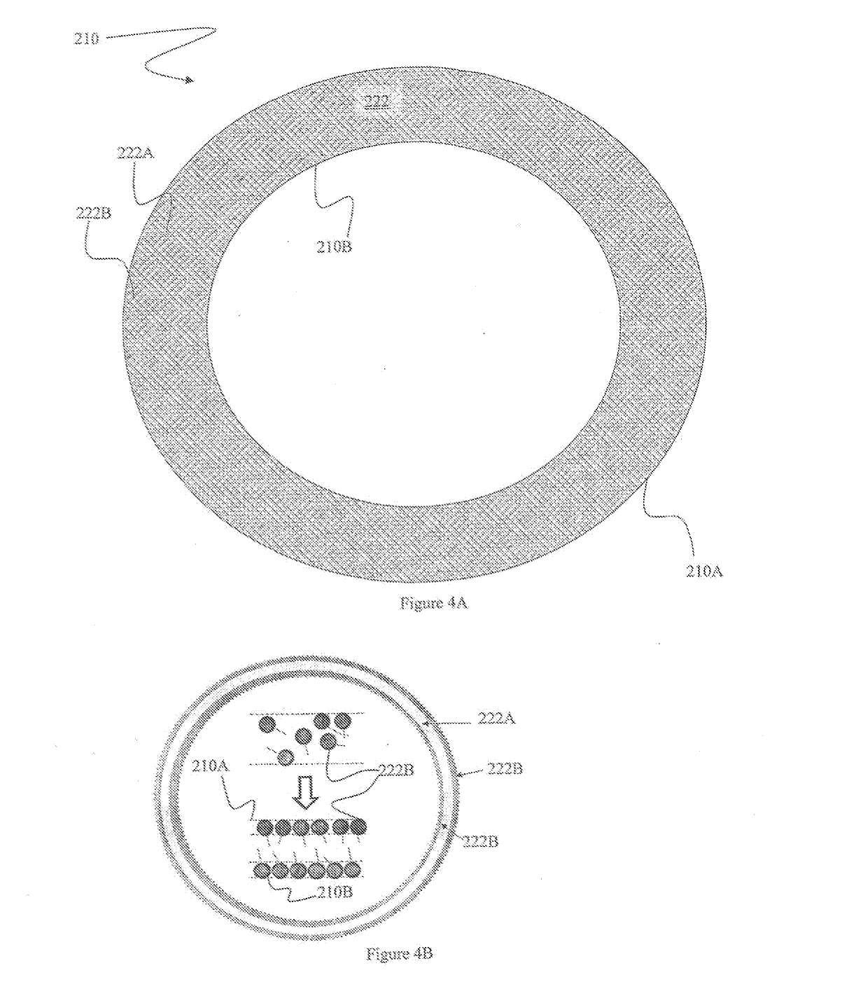

FIG. 3A is a schematic representation of how a marine organism attaches to a surface. As depicted, a barnacle (not shown) uses an aqueous glue 50 to attach to a polyurethane surface 60. The aqueous glue 50 comprises an aqueous based mixture of proteins and polysaccharides excreted by the barnacle larvae to enable adhesion. Initial adhesion is promoted by provision of a hydrophilic surface such as a typical seismic streamer surface, wherein the hydrophilic surface provides a contact angle 60 that is less than 90 degrees.

FIG. 3B illustrates a contact angle for an untreated polyurethane streamer casing. An untreated skin 70 of the seismic streamer in FIG. 3 is relatively water wetting with a contact angle 75 of about 68.70°. As such, the untreated skin 70 is hydrophilic and prone to biofouling.

FIG. 3C is a schematic representation of how an initial attachment of marine organisms to surfaces can be reduced via provision of hydrophobic surfaces (contact angle greater than 90 degree). As provided in FIG. 3C, a treated surface 80 comprises polyurethane with a silicon coating. The silicon coating erases a contact angle 85 of the treated surface 80 to be greater than 90 degrees. As a result of the contact angle 85 being greater than 90 degrees a marine organism (not shown), in this example a barnacle larvae, cannot adhere to the treated surface 80 using an aqueous glue 50 comprising an excreted aqueous based mixture of proteins and polysaccharides.

Changes to the contact angle of the skin of the seismic streamer may be produced by applying a coating. A large change in the contact angles was observed with the application of a silicone coating comprising an aminoalkyl functionalized polydimethylsiloxane. However, such a silicone coating is very difficult to apply to the streamer skin due to the contrast in the chemical nature of the coating and the polyurethane of the seismic streamer. Furthermore, Applicants have observed that in brine at 40° C., an ageing process takes affects the coated polyurethane streamer skin leading to the removal of the coating from the streamer surface. This removal of the coating due to ageing leaves areas of the original polyurethane exposed and at risk of biofouling.

As discussed above, because of the issues inherent to coating strategies, in particular poor adhesion and premature removal from the polyurethane surface during exposure or use, an alternative approach is required to generate, among other things, a durable antifouling technology that can prevent biofouling over an extended period of operation of a seismic streamer.

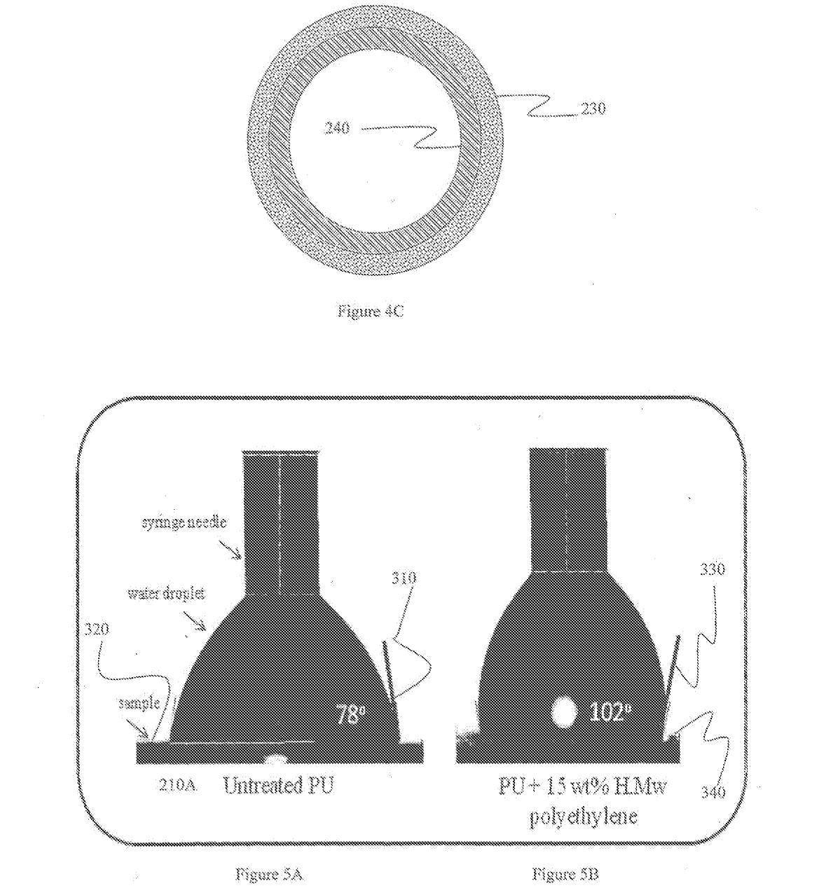

FIG. 4A illustrates antifouling additives localized throughout a streamer skin in accordance with an embodiment of the present invention. In an embodiment of the present invention, a streamer skin 222—also often referred to as an outer-housing, streamer casing and/or the like—is used to contain the acoustic equipment (not shown) of a towed seismic streamer array. In an embodiment of the present invention, the streamer skin 222 comprises a base material 222A, such as polyurethane, thermoplastic polyurethane (“TPU”) and/or the like. The base material 222A may also comprise urethane, polyvinylchloride, polyethylene and/or the like. Generally, polyurethane is the most widely used material for seismic streamers.

In an embodiment of the present invention, antifouling additive 222B is localized throughout a streamer skin 222. In an embodiment of the present invention, the antifouling additive 222B may comprise compounds that are configured to increasing a surface hydrophobicity of the streamer skin 222 and/or reduce a surface energy of the streamer skin 222. The hydrophobicity of the streamer skin 222 may be increased by increasing a contact surface angle of the streamer skin 222.

To provide that the antifouling additive 222B are localized throughout the streamer skin 222, the antifouling additive 222B may be mixed with the base material 222A of the streamer skin 222 before the streamer skin 222 is extruded onto the seismic streamer. Merely by way of example, one method of providing that the antifouling additive 222B are localized throughout the streamer skin 222 is to add the antifouling additive 222B to a molten form of the base material 222A. Another method is to take pellets of the antifouling additive 222B and the base material 222A and melt the pellets together. Blending or mixing techniques may be used to provide for mixing of the antifouling additive 222B with the base material 222A. In other aspects of the present invention, other methods of blending/mixing of the antifouling additive 222B with the base material 222A may be used. In an embodiment of the present invention, a mixture of the base material 222A and the antifouling additive 222B may be heat-extruded onto a seismic streamer.

By mixing the antifouling additive 222B and the base material 222A to create a streamer skin, the contact angle of the streamer skin is manipulated without the need to add a coating to the streamer skin. As such, in accordance with an embodiment of the present invention, the streamer skin provides a durable and effective anti-biofouling streamer skin without the detrimental properties associated with a coated streamer skin. Applicants have determined that a streamer skin comprising both the base material 222A and the antifouling additive 222B is durable and effective as a streamer skin. Moreover a streamer skin in accordance with an embodiment of the present invention may have antifouling additive 222B present on both an inner surface 210B and an outer-surface 210A of the streamer skin. In an embodiment of the present invention, the presence of the antifouling additive 222B on the inner surface 210B may provide for ease of extrusion of the streamer skin over a solid or gel streamer. Merely by way of example, where the antifouling additive 222B is a silicon, the silicon may aid the extrusion of the streamer skin onto a solid/gel streamer.

As illustrated in FIG. 4B, in one embodiment of the present invention, the antifouling additive 222B may comprise compounds, polymers and/or the like that preferentially migrate to the inner surface 210B and/or the outer-surface 210A of the streamer skin 222. To provide for the migration of the antifouling additive 222B to the inner surface 210B and/or the outer-surface 210A, in an aspect of the present invention, the antifouling additive 222B may comprise ultra-high molecular weight or high molecular weight elements/compounds. In an aspect of the present invention, ultra-high molecular weight or high molecular weight elements/compounds tend move preferentially in the streamer skin 222 to the inner surface 210B and/or the outer-surface 210A of the streamer skin 222. As such, the ultra-high molecular weight or high molecular weight elements/compounds provide a means to incorporate so additive throughput the streamer skin 222 that has an increased effect on a surface of the streamer skin 222. This provides for attaining a surface effect without using a paint or a coating.

Merely by way of example, in certain aspects of the present invention, the ultra-high molecular weight or high molecular weight elements/compounds may comprise ultra-high or high molecular weight siloxane polymers. Such high/ultra-high molecular weight siloxane polymers may be provided in a pelletized form in different plastic carrier resins and these pellets may be melted and mixed with a melt of the TPU. Other ultra-high molecular weight or high molecular weight elements/compounds may comprise fluoro-polymers, silicon polymers and/or the like.

In other aspects of the present invention, the ultrahigh molecular weight or high molecular weight elements/compounds may comprise a siloxane gum. In such aspects, the siloxane gum may be used to form a dispersion within the polymer melt that may be blended prior to extrusion of the streamer skin. Other ultrahigh molecular weight or high molecular weight elements/compounds may be used in other embodiments of the present invention, where the ultrahigh molecular weight or high molecular weight elements/compounds comprise a hydrophobic moiety, such as fluorine, silicone and/or the like, and a base material, such as a polymer, configured to give the compound the high molecular weight, which high molecular weight causes the compound to migrate to the surface. Merely by way of example, such a high molecular weight additive may comprise a high molecular weight polyethylene species, an ultra-high-molecular-weight polyethylene species and/or a fluorine or silicon derivatized high molecular weight polyethylene species or fluorine or silicon derivatized ultra-high-molecular-weight polyethylene species.

In an embodiment of the present invention, fluoro-polymers, silicone, silicone derivatives, fluoro-silicones,, high molecular weight polyethylene species and or the like are distributed throughout the streamer skin 222. In accordance with an embodiment of the present invention, the fluoro polymers, silicone, silicone derivatives, fluoro-silicones, high molecular weight polyethylene species form a modulated antifouling barrier on the streamer skin 222. In addition to the antifouling additive 222B, biocides (not shown) may also be localized throughout the streamer skin 222 to provide a secondary defense against biofouling.

In an embodiment of the present invention, the localization of the antifouling additive 222B throughout the base material 222A and/or the streamer skin 222 provides that the antifouling additive 222B are provided at the outer-surface 210A where the antifouling additive 222B sets to increase the contact angle and/or reduce the surface energy of the outer-surface 210A to prevent biofouling of the streamer skin 222. By localizing the antifouling 222B throughout the base material 222A and/or the streamer skin 222, the detrimental effects—such as delamination, erosion and/or the like—of painting and/or coating the streamer skin are avoided.

By localization the antifouling additive 222B throughout the base material 222A and/or the streamer skin 222, in embodiments of the present invention, antifouling additive 222B are present at the inner surface 210B of the streamer skin 222. In aspects of the present invention where the seismic streamer comprises a kerosene filler material, the antifouling additive 222B may be selected to prevent adverse interactions between the kerosene and the antifouling additive 222B. For example, in certain aspects of the present invention, the antifouling additive 222B may comprise Teflon, PTFE, polyethylene or the like.

However, it may not be possible or desirable to select an antifouling additive that does not adversely interact with kerosene. Additionally, it may be desirable to fabricate the streamer skin from a multilayer polymer. For example, the layers of the multilayer polymer skin may be configured to provide that the outer-layer provides a hard resilient, impermeable surface and an inner-layer(s) provide a more malleable layer that can conform to use inner structure of the streamer.

FIG. 4C illustrates a multilayer polymer streamer skin, in accordance with an embodiment of the present invention. In an embodiment of the present invention, an outer-skin 230 of the streamer casing comprises the base material 222A and the antifouling additive 222B, where the antifouling additive 222B is localized throughout the outer-skin 230. An inner-skin 240 may comprises the base material 222A. In an embodiment of the present invention, the outer-skin 230 and the inner-skin 240 are heat extruded simultaneously to form a multilayer polymer. By heat extruding the outer-skin 230 and the inner-skin 240 simultaneously, the base material 222A in the outer-skin 230 thermally interacts with the base material 222A in the inner-skin 240 to provide for effectively integration of the outer-skin 230 with the inner-skin 240. In this way, instead of there being a boundary layer between the outer-skin 230 and the inner-skin 240, the outer-skin 230 and the inner-skin 240 are annealed to each other to effectively form a multilayer polymer. This annealing of the outer-skin 230 with the inner-skin 240 provides that, unlike with a bio-fouling coating, the outer-skin 230 will not delaminate from the inner-skin 240. In an embodiment of the present invention, the outer-skin 230 and the inner-skin 240 may be simultaneously heat extruded onto a seismic streamer. In certain aspects, the seismic streamer may comprise a kerosene filler, a solid filler and/or a gel filler.

In some embodiments of the present invention, an antifouling streamer casing may be applied to a seismic streamer comprising a solid, gel and/or the like filler material (not shown). Merely by way of example, the solid/gel filler may comprise Kraton thermogel or other forms of thermogels and the thermogel may be mixed with a material such as Isopar M or the like. In such embodiments, the presence of the antifouling additive 222B on the inner-surface 201B may not cause adverse interactions between the antifouling additive 222B and the solid/gel filler. As such, in embodiments of the present invention, fluoro polymers, silicone, silicone derivatives, fluoro-silicones, high molecular weight polyethylene species and or the like may be used as the antifouling additive 222B for seismic streamers comprising a solid/gel filler. Moreover, in certain aspects of the present invention, the presence of the antifouling additive 222B at the inner-surface 210B may provide for improved fabrication of the solid/gel filler type seismic streamer.

In embodiments of the present invention, the localization of the antifouling additive 222B throughout the base material 222A and/or the streamer skin 222 provides that the outer-surface 210A of the streamer skin 222 is free of coatings or paints. In some aspects of the present invention, the outer-surface 210A may be heat treated and or the like to be a hard shiny surface. In embodiments of the present invention, the outer-surface 210A may be provided so that it is unadulterated, smooth, hard and shiny and/or the like, where such a surface may help, in combination with the increased contact angle/low surface energy of the outer-surface 210A, to prevent biofouling.

As a non-limiting illustrative example, in an embodiment of the present invention, the antifouling additive 222B may comprise fluoroaliphatic stearate ester fluorosurfactant (e.g. MASURF FS-1400). MASURF FS-1400 is known as a ‘polymer melt additive’ and takes the form of a 100% active light tan solid. In an embodiment of the present invention, an additive, such as MASURF FS-1400 or the like, migrates to the surface of the polyurethane matrix during the extrusion process. As such, the antifouling additive preferentially concentrates at the location whereby fouling organisms would colonize.

In an embodiment of the present invention, the antifouling additive 222B may comprise levels in the range of 10-100 part-per-million of the streamer skin 222. Such concentration levels of antifouling additive 222B may, among other things, reduce manufacturing costs. Furthermore, in such embodiments of the present invention, because the antifouling additive 222B is incorporated in the streamer skin 222 at such low concentrations, the bulk properties (e.g. hardness, tensile strength, permeability etc.) of the streamer skin 222, i.e., the polyurethane base material or the like of the streamer skin 222, are not unduly affected.

In other embodiments, a high molecular weight polyethylene species may be used as the antifouling additive 222B. Merely by way of example, such molecules are available from Inhance Products (e.g. from the UH1000 series). In aspects of the present invention, UH1000 or the like may be mixed with the base material 222A via a melt blending process prior to extrusion of the streamer skin 222. The UH1000 may provide for modifying the contact angle/surface energy of a surface of the streamer skin 222.

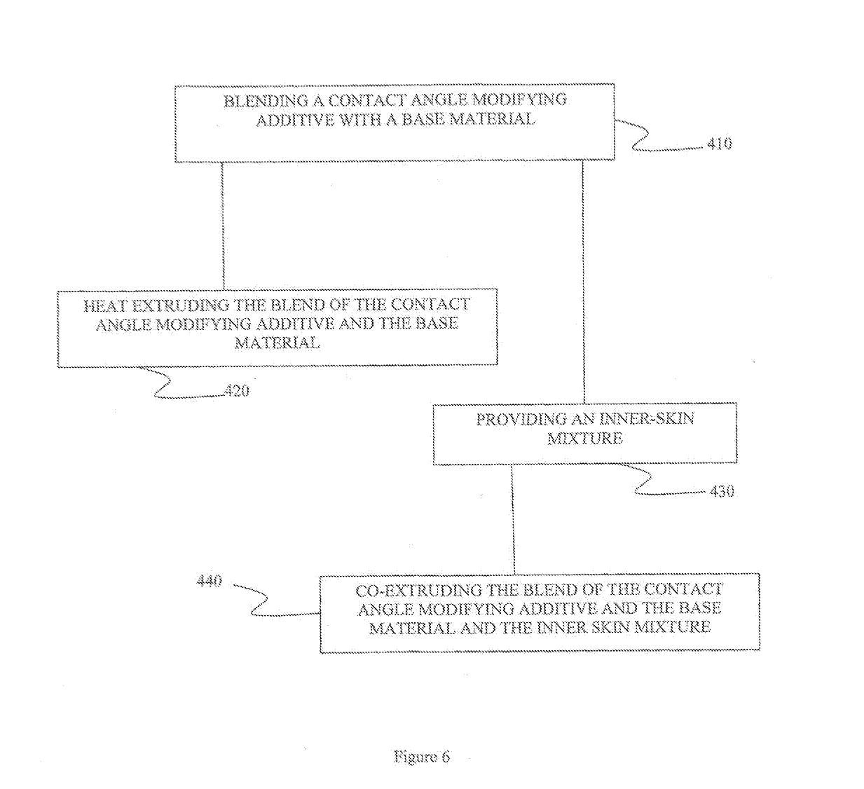

FIG. 5A illustrates a contact angle 310 of an untreated surface 320 of a surface of a polyurethane streamer skin. As provided in FIG. 5A, the untreated surface 320 comprises polyurethane and is relatively water-wetting yielding the contact angle 310 (a water-in-air contact angle) of 78 degrees, i.e. a hydrophilic surface.

FIG. 5B illustrates a contact angle 330 of a treated surface 340 of a polyurethane streamer skin. The polyurethane streamer skin, comprises antifouling additives dispersed throughout the streamer skin. As provided in FIG. 5B, the polyurethane comprises an additive concentration of 15 wt % of UH1000 and this combination provides that the contact angle 340 is 102 degrees, i.e. a hydrophobic surface.

In alternative embodiments, the antifouling additives may comprise a micronized polytetrafluoroethylene (PTFE) such as Polymist 554. In such embodiments, the PTFE may be blended with the base material of the streamer skin during the melt processing stage. The blended mixture may then, in some aspects of the present invention, be heated and extruded into pellets. In some embodiments of the present invention, the pellets may then be heat extruded to form a streamer skin of desired specification (outer-diameter, inner-diameter, length etc.).

As provided above, the antifouling additives may comprise fluoro-polymers, silicone, silicone derivatives, fluoro-silicones, high molecular weight polyethylene species and/or the like. In an embodiment of the present invention, localization of one or more of such antifouling additives throughout the streamer skin may provide for contact angles of a surface of the streamer skin of greater than 100 degrees, greater than 110 degrees or greater than 120 degrees. This higher contact angles preventing organisms from attaching to the streamer skin.

Although in some embodiments the antifouling additives take the form of a solid, in other embodiments the antifouling additives may comprise liquid additives. Merely by way of example, in some aspects of the present invention, a liquid antifouling additive may be added to the melt processing stage of the fabrication of the streamer skin via a preliminary stage. In such an embodiment, a base material, such as TPU, may be coated in a liquid antifouling additive, i.e., polydimethylsiloxane (PDMS, liquid), and dried. Merely by way of example, in some aspects the coated TPU may be dried at 65 degrees Centigrade in a nitrogen atmosphere. The modified TPU may then be melted, extruded, pelleted and blended with unmodified TPU to generate a modified TPU comprising a mixture of the TPU and the antifouling additive. Such embodiments of the present invention provide for the use of species containing any of the liquid-based silicones, fluoro-polymers, fluoro-silicones as the antifouling additive.

Some embodiments of the present invention, provide for modifying the surface properties of the streamer skin, which may comprise polyurethane, TPU or the like, via addition of fluoro-polymers, silicone, fluorosilicone or high molecular polyethylene additives during the manufacturing process. Silicones may be localized throughout the streamer skin to reduce the surface energy and increase the contact angle of the streamer skin. Fluorinated polymers have an even lower surface energy than silicones, as such, these materials are used as antifouling additives in certain embodiments of the present invention. The low surface energy of fluoropolymers is derived from the low bond polarization of the C—F bond.

In embodiments of the present invention, the streamer skin may comprise biocidal additives in addition to the antifouling additives. In certain aspects, the biocide may take the form of, but is not limited to, nanoparticles of silver, copper oxide or zinc oxide, quaternary ammonium salts and organic species, such as benzoic acid, tannic acid or capsacain. In an embodiment of the present invention, the biocide may be blended with the antifouling additives prior to blending with the base material of the streamer skin. In other embodiments, the biocidal materials may be coated on the streamer skin, which streamer skin includes the antifouling additives localized throughout. The biocidal elements may prevent the build-up of marine species, including micro-foulers (which are food sources for the macrofoulers), on the seismic streamer. In further aspects, the biocide may be mixed with an inner-skin of a multilayer polymer streamer skin.

FIG. 6 illustrates a method of fabricating a seismic streamer skin with a contact angle modifying additive localized throughout at least a layer of the streamer skin. In step 410 a contact angle modifying additive is blended with a base material for forming the streamer skin. The contact angle modifying additive comprises an additive that when present on a surface of the base material modifies the contact angle of the surface. As provided above, the contact angle modifying additive may comprise a fluoro-polymer, silicone, silicone derivatives, fluoro-silicones, high molecular weight polyethylene species and/or the like that may increase the contact angle of the surface and thereby prevent the adhesion of organisms onto the surface. In step 410, a biocide or the like may also be mixed with the base material.

In some embodiments, in step 410, use contact angle modifying additive may be mixed with a portion of the base material. As provided above, the base material of the streamer skin may comprise polyurethane, TPU and/or the like. In certain aspects, the mixture of the contact angle modifying additive and the portion of the base material may be heated and turned into pellets. In other embodiments, the contact angle modifying additive may be provided in a pellet form and heated with pellets of the base material to provide for mixing of the contact angle modifying additive and the base material. In yet other embodiments, the contact angle modifying additive may be directly blended into a heated mixture of the base material.

In step 420 the mixture of the contact angle modifying additive and the base material may be heat extruded onto a seismic streamer. In aspects of the present invention where the contact angle modifying additive has been mixed with the portion of the base material and turned into pellets, these pellets may be mixed with pellets of the base material and heat extruded onto the seismic streamer. In aspects of the present invention where the contact angle modifying additive has been mixed with the base material and turned into pellets, these pellets may be heat extruded onto the seismic streamer. In other aspects, the base material may be heated, blended with the contact angle modifying additive and extruded onto the seismic streamer. In certain aspects of the present invention, the seismic streamer may comprise a kerosene filler and the blend of contact angle modifying additive and the base material may be extruded and/or co-extruded over a seismic skin that does not comprise the contact angle modifying additive.

In step 430, an inner skin mixture may be provided. The inner-skin mixture may comprise polyurethane, TPU and or the like. The inner-skin mixture may be in the form of pellets, granules or the like. In some aspects of the present invention, the inner-skin mixture may comprise polyurethane, TPU and or the like melt blended with biocide (micro/nanoparticles of silver, copper etc), which is then extruded and granulated/pelletised to yield inner-skin pellets.

In step 440, the mixture of the contact angle modifying additive and the base material and the inner-skin mixture may both be melted and simultaneously extruded onto the seismic streamer. In this way the two mixtures—the mixture of the contact angle modifying additive and the base material and the inner-skin mixture—may be used to form a self-supporting tubing that does not collapse on itself during the extrusion process. The mixture of the contact angle modifying additive and the base material may be extruded onto the inner-skin to produce a multi (dual(-layer polyurethane-based tubing. In certain aspects, the mixture of the contact angle modifying additive and the base material and the inner-skin mixture may both be simultaneously heat extruded to form a multilayer polymer and the multilayer polymer may then be extruded onto the seismic streamer. In aspects of the present invention, the inner skin mixture and the outer skin mixture are heat extruded simultaneously to provide that the two mixtures anneal with each other.

In an embodiment of the present invention, the outer casing is configured to comprise a high contact angle, low surface energy surface and the inner skin is configured to comprise biocidal properties. In aspects of the present invention, the base material of the mixture of the contact angle modifying additive and the base material and the inner-skin mixture is the same, as such, by simultaneously heat extruding the two mixtures the two mixtures anneal to one another, the base material effectively integrates across the layers of the formed multilayer polymer preventing the disintegration, delamination issues that occur when a coating is applied to the streamer skin.

While the principles of the disclosure have been described above in connection with specific apparatuses and methods, it is to be clearly understood that this description is made only by way of example and not as limitation on the scope of the invention.

1. An anti-biofouling casing for a seismic streamer, comprising:
an outer-skin, the outer skin comprising a mix of a base material and a molecular additive, wherein:
the molecular additive is localized throughout the base material; and
the molecular additive is configured to impart a high contact angle and/or a low surface energy to an outer surface of the anti-biofouling casing to prevent adhesion of living organism thereto.

2. The anti-biofouling casing of claim 1, further comprising:
an inner-skin, the inner-skin comprising the base material, wherein the inner-skin and the outer-skin comprise a multi-layer casing.

3. The anti-biofouling casing of claim 2, wherein the outer-skin is annealed to the inner-skin.

4. The anti-biofouling casing of claim 3, wherein the annealing of the outer-skin to the inner-skin is produced by heating and co-extruding the inner-skin and the outer-skin.

5. The anti-biofouling casing of claim 1, wherein the base material comprises one of polyurethane, thermoplastic polyurethane, urethane, polyvinylchloride and polyethylene.

6. The anti-biofouling casing of claim 1, wherein the molecular additive comprises one of a fluorine derivatized polymer, a silicone, a silicon derivatized polymer, a fluorosilicone, a high molecular weight polyethylene, a fluorine derivatized high molecular weight polyethylene and a silicon derivatized high molecular weight polyethylene.

7. The anti-biofouling casing of claim 1, wherein the molecular additive comprises at least one of polydimethylsiloxane, polytetrafluoroethylene, and fluoroaliphatic stearate ester fluorosurfactant.

8. The anti-biofouling casing of claim 1, wherein the molecular additive comprises an ultrahigh molecular weight or high molecular weight compound, and wherein the ultrahigh molecular weight or high molecular weight compound comprises a hydrophobic moiety.

9. The anti-biofouling casing of claim 8, wherein the ultrahigh molecular weight or high molecular weight compound comprises at least one of a siloxane gum and a siloxane polymer.

10. The anti-biofouling casing of claim 8, wherein the hydrophobic moiety comprises at least one of fluorine, a fluorine derivative, silicon and a silicon derivative.

11. The anti-biofouling casing of claim 1, wherein the molecular additive comprises between 0-15 weight-percent of the outer-skin.

12. The anti-biofouling casing of claim 1, wherein the molecular additive comprises between 10-100 parts-per-million of the outer-skin.

13. The anti-biofouling casing of claim 1, wherein the molecular additive is configured to provide that the outer-surface comprises a contact angle greater than at least one of 80, 90, 100 and 110 degrees.

14. The anti-biofouling casing of claim 1, further comprising:
a streamer body, wherein:
the streamer body comprises one or more sensors, a strength member and a filler material; and
the anti-biofouling casing covers an exterior of the streamer body.

15. The anti-biofouling casing of claim 14, wherein the filler comprises at least one of kerosene.

16. The anti-biofouling casing of claim 14, wherein the filler comprises at least one of a solid material and a gel.

17. The anti-biofouling casing of claim 1, further comprising:
a biocide.

18. The anti-biofouling casing of claim 2, wherein the inner-skin comprises a biocide.

19. The anti-biofouling casing of claims 17, wherein the biocide comprises one of a polyethylene oxide, a polyacrylamide, a quaternary ammonium salt e.g., benzylalkonium, a chloride and an organic compound such as Diuron, benzoic acid, tannic acid or capsacain and nano/microparticles of silver, copper oxide or zinc oxide.

20. The anti-biofouling casing of claim 1, wherein the mix of the base material and the molecular additive is produced by heat extruding a first set of pellets comprising the base material and a second set of pellets comprising the molecular additive.

21. The anti-biofouling casing of claim 1, wherein the mix of the base material and the molecular additive is produced by melt blending the base material and the molecular additive and heat extruding the blend.

22. The anti-biofouling casing of claim 1, wherein the casing comprises a smooth outer-surface.

23. A method of fabricating a seismic streamer using an anti-biofouling casing according to claim 1, comprising:
extruding the anti-biofouling casing onto the seismic streamer.

24. A method of fabricating a seismic streamer skin using an anti-biofouling casing according to claim 2, comprising:
co-extruding the inner-skin and the outer-skin to form the seismic streamer skin.

25. The method of fabricating the seismic streamer skin according to claim 23, further comprising:
heat extruding the inner-skin and outer-skin simultaneously to provide for annealing the inner-skin to the outer-skin.

26. The method of fabricating the seismic streamer skin according to claim 24, wherein the inner-skin and outer-skin are extruded directly onto the seismic streamer.

27. The method according to claim 24, wherein the inner-skin and the outer-skin produce a self-supporting tubing that does not collapse on itself during the extrusion process.

28. The method according to claim 24, wherein the outer-skin is processed to have a hard, impermeable outer surface.

29. The method according to claim 24, wherein the outer-surface is smooth.

30. A method of fabricating an anti-biofouling casing for a seismic streamer, comprising:
mixing a base material and a molecular additive, wherein the molecular additive is configured to impart a hydrophobic and/or low surface energy to an outer surface of the anti-biofouling casing to prevent adhesion of living organism thereto; and
heat extruding the mixture of the base material and the molecular additive.

31. The method of fabricating the anti-biofouling casing for a seismic streamer according to claim 30, further comprising:
forming the heat extruded mixture into a plurality of pellets.
